(19) United States
(12) Patent Application Publication
(10) Pub. No.: US 2018/0137022 A1
(43) Pub. Date: May 17, 2018

(54) ARITHMETIC OPERATION DEVICE AND VIRTUAL DEVELOPMENT ENVIRONMENT APPARATUS

(71) Applicant: RENESAS ELECTRONICS CORPORATION, Tokyo (JP)

(72) Inventors: Yutaka FUNABASHI, Tokyo (JP); Masahiro KOKUBO, Tokyo (JP); Yasushi ONISHI, Tokyo (JP); Takuya TAKIZAWA, Tokyo (JP)

(21) Appl. No.: 15/786,350

(22) Filed: Oct. 17, 2017

(30) Foreign Application Priority Data
Nov. 15, 2016 (JP) 2016-222119

(51) Int. Cl. G06F 11/22; G06F 9/30; G06F 11/26; G06F 11/07

(52) U.S. Cl. CPC G06F 11/2273; G06F 11/0712; G06F 11/261; G06F 9/3001

(57) ABSTRACT

Provided are an arithmetic operation device and a virtual development environment apparatus making it possible to give desirable control including desirable fault injection from a test program to a virtual device model at a desirable timing.

### CROSS-REFERENCE TO RELATED APPLICATIONS

The disclosure of Japanese Patent Application No. 2016-222119 filed on Nov. 15, 2016 including the specification, drawings and abstract is incorporated herein by reference in its entirety.

### BACKGROUND

The present disclosure relates to an arithmetic operation device and a virtual development environment apparatus and is, in particular, applicable to the arithmetic operation device and the virtual development environment apparatus using virtual device models.

In the automobile industry, application of the functional safety standard ISO26262 and standard conformance are becoming indispensable in development of electric and electronic components and software of microprocessors to be loaded on these electric and electronic components. In automobile manufacturers and, for example, suppliers of semiconductor devices to be loaded on vehicles such as microcomputers and so forth, arrangement and construction of a model base development environment, that is, a virtual development environment using the virtual device models are being conducted in order to meet this requirement. In the virtual development environment for an on-vehicle electronic control unit (ECU), for example, development and verification of a system control application program for the ECU are conducted by using a virtual device model (a virtual ECU model) of the ECU as a development object (hereinafter, referred to as a “development-object ECU”) and a system test program for the ECU. The virtual device model for the microcomputer (the virtual microcomputer model) used in the development-object ECU is included in the virtual device model for the development-object ECU (hereinafter, referred to as a “virtual ECU model”). In development and verification of the system control application program for the ECU, desirable fault injection is performed on, for example, the virtual microcomputer model so as to promote development and verification of the development-object system control application program and upgrading of the development-object system control application program. Incidentally, the virtual device model is a software model by which it is possible to perform a simulative operation (simulation) by, for example, virtually replacing an operation of target hardware.

It is disclosed in Japanese Unexamined Patent Application Publication No. 2014-64239 that “a mobile object communication terminal test system includes a test device provided with a command generation unit 2 which generates a terminal control command by receiving operation instructions for controlling a mobile object communication terminal and generates a measurement control command by receiving operation instructions for measurement control, a storage unit 13 which sequentially stores the commands generated by the command generation unit as a command sequence, a command execution unit 15 which receives the command sequence and outputs the command stored in the command sequence concerned and a measurement unit 163 which performs measurement on the mobile object communication terminal on the basis of control from a test control unit 160 which performs measurement control on the basis of the command from the command execution unit and a test application 20 which is stored in the mobile body communication terminal and is used to control the mobile objet communication terminal by receiving terminal control instructions”.

### SUMMARY

According to the technology disclosed in Japanese Unexamined Patent Application Publication No. 2014-64239, user IF processing in a user system test program is controlled from the test device on the basis of various commands at a free timing. However, it is found that there exists such an issue that it is difficult to control a virtual microcomputer model which is present in the virtual ECU model even in a case where the technology of Japanese Unexamined Patent Application Publication No. 2014-64239 is applied.

The inventors and others of the disclosure have made a study on arrangement and construction of the virtual development environment and have found that there exist such requests as follows.

There exists such a request that in development of the ECU system control application, development be performed antecedently before completion of a semiconductor device to be utilized in the ECU, that is, in a state where the ECU is not yet produced as actual hardware thereby to reduce a development period. In addition, there also exists such a request that verification of the system control application which would be increased in volume and complicated be more efficiently performed in application of the system control application to drive assist and self-driving. In addition, there further exists such a request that verification of the system control application be performed even in a state where the ECU is produced in reality thereby to promote efficiency of verification and upgrading of the system control application.

In addition, it is also requested that a large number of test patterns be made and verification of the system control application by using these test patterns be performed as a result of application of the system control application to drive assist and self-driving. In addition, there exist not a small number of test patterns on the basis of which it is difficult to cause a fault to occur in reality. In such a case, it is possible to pseudoly induce an abnormal state by injecting the fault into the virtual device model. Accordingly, it is thought that fault injection into the virtual device mode is a technology which is important not only for upgrading which is realized by full-length use of the test patterns but also for efficiency of development of the system control application in the sense that the abnormal state corresponding to each test pattern is constructed with ease. Further, a request that fault injection into the virtual device mode be performed at an optional timing and a request that fault injection be performed efficiently somehow for full-length use of the large number of test patterns are also made positively.

The subject of the present disclosure is to provide an arithmetic operation device and a virtual development environment apparatus making it possible to give desirable control including desirable fault injection from the test program to the virtual device model at a desirable timing.

Other matters to be solved and novel features of the present disclosure will become apparent from description of the specification and the appended drawings.

A summary of representative embodiments of the present disclosure will be briefly described as follows.

That is, each of the arithmetic operation device and the virtual development environment apparatus includes an interface section for coupling together the test program and the virtual device model.

According to the arithmetic operation device and the virtual development environment apparatus of the present disclosure, it becomes possible to give the desirable control from the test program to the virtual device model at the desirable timing.

### BRIEF DESCRIPTION OF THE DRAWINGS

FIG. 1 is a diagram illustrating one example of a virtual development environment apparatus VM1 according to a first embodiment.

FIG. 2 is a conceptual diagram illustrating one example of a hardware configuration of the virtual development environment apparatus VM1 illustrated in FIG. 1.

FIG. 3 is a diagram illustrating one example of a configuration of a device control software part DCS1 in FIG. 1.

FIG. 4 is an explanatory diagram illustrating one example of a virtual development environment B1 according to a comparative example and a virtual development environment B2 according to the first embodiment.

FIG. 5 is a conceptual diagram illustrating one configuration example of a virtual development environment apparatus according to a second embodiment.

FIG. 6 is a diagram illustrating an application example of the virtual development environment apparatus according to the first embodiment.

### DETAILED DESCRIPTION

In the following, preferred embodiments, a comparative example and an application example of the present disclosure will be described using the drawings. However, in the following description, there are cases where the same symbols are assigned to the same constitutional elements and repetitive description thereof is omitted. Incidentally, although there are cases where a constitutional element is more schematically illustrated in each drawing than the actual form of that constituent element for more clarification of the description, it is merely one example and does not limit interpretation of the present disclosure.

### First Embodiment

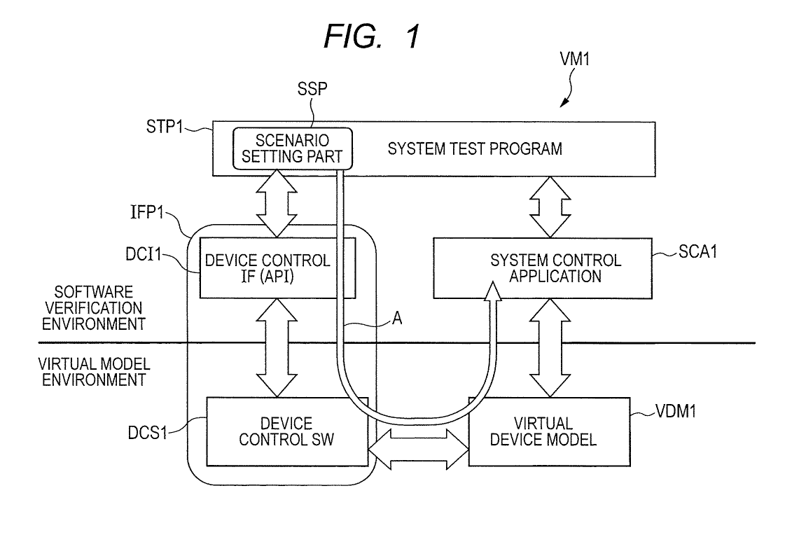

FIG. 1 is a conceptual diagram illustrating one example of the virtual development environment apparatus VM1 according to a first embodiment.

The virtual development environment apparatus VM1 constructs a virtual development environment which includes a software verification environment (a system test program STP1, a system control application SCA1 and a device control IF (AP1) DCI1) and a virtual model environment (a device control SW DCS1 and a virtual device model VDM1). The virtual development environment apparatus VM1 may be regarded as a development support apparatus or a simulation apparatus which verifies the system control application SCA1 which is a development and verification object in accordance with a system test program which is a verification program.

The virtual development environment apparatus VM1 further includes an interface section IFP1 and the virtual device model VDM1. The interface section IFP1 serves to relay instructions issued from the system test program STP1 in order to control the virtual device model VDM1. The interface section IFP1 includes a device control interface part (a device control IF (API)) DCI1 and the device control software part (a device control SW) DCS1.

The device control interface part DCI1 outputs (that is, operates so as to output (the same is true of other software)) a command and a signal issued from a scenario setting part SSP of the system test program STP1 to the device control software part DCS1 and outputs an input signal from the device control software part DCS1 to the system test program STP1. The device control software part DCS1 outputs instructions and a signal to the virtual device model VDM1 in accordance with the command and the signal from the device control interface part DCI1 and supplies an output signal from the virtual device model VDM1 to the device control interface part DCI1. Incidentally, the device control interface part DCI1 may be incorporated into the system test program STP1 as a part of the system test program STP1.

That is, it is possible for the system test program STP1 to perform desirable control of intentional fault injection, an intentional delay in response and so forth on the virtual device model VDM1 via the device control interface part DCI1 or the device control software part DCS1. For example, the system control application SCA1 is a system control application for an on-vehicle electronic control unit (ECU) and the virtual device model VDM1 is a virtual device model of a microprocessor and/or a microcomputer used in the ECU.

It is also possible for the system test program STP1 to give various signals to the system control application SCA1. The system control application SCA1 executes processing concerned in accordance with the given signal and gives an order to the virtual device model VDM1. The virtual device model VDM1 executes the received order and outputs a result of execution to the system control application SCA1. Thereby, verification of the operation of the system control program SCA1 in accordance with the system test program STP1 is performed.

The system test program STP1 controls the virtual device model VDM1 via the device control interface part DCI1 and the device control software part DCS1 as described above. Thereby, it becomes possible for the system test program STP1 to perform, for example, control for intentionally causing the fault to occur as the fault injection or control for intentionally causing the delay in response to occur on the virtual device model VDM1. The system test program STP1 includes the scenario setting part SSP in order to perform desirable control of the fault injection and the response delay on the virtual device model VDM1 at an optional timing. A plurality of scenarios may be set in the scenario setting part SSP. The scenario means scheduling of test patterns relating to control of the fault injection, the response delay and so forth on the basis of which it is desirable to perform test and verification on the virtual device model VDM1 and each scenario is made for each test pattern.

Accordingly, it is possible for the system test program STP1 to perform the fault injection and the response delay on the virtual device model VDM1 at the optional timing in accordance with one scenario selected from within the plurality of scenarios set in the scenario setting part SSP as indicated by an arrow A in FIG. 1. Further, it is also possible for the system test program STP1 to verify the operation of the virtual device model VDM1 in a case where the fault injection and injection of the desirable control have been performed on the virtual device model VDM1 and the operation of the system control application SCA1 to the response.

When the system control application SCA1 obtained after development and verification is loaded on a product such as, for example, the on-vehicle electronic control unit (ECU) and so forth, the virtual device model VDM1 is a virtual device model which is replaced with a real semiconductor device (for example, the microprocessor and the microcomputer as semiconductor integrated circuits) and operates in the virtual space. The scenario setting part SSP of the system test program STP1 and the interface section IFP1 are functions used for development and verification of the system control application SCA1 and are removed when the system control application SCA1 is loaded on the product. The system control application SCA1 and the system test program STP1 excluding the scenario setting part SSP are parts which are left unremoved also after loaded on the product and operate in the real space. The interface section IFP1 acts as a mediator between the real space and the virtual space so as to make mutual cooperation and coupling of the constitutional elements in the real space and the virtual space possible.

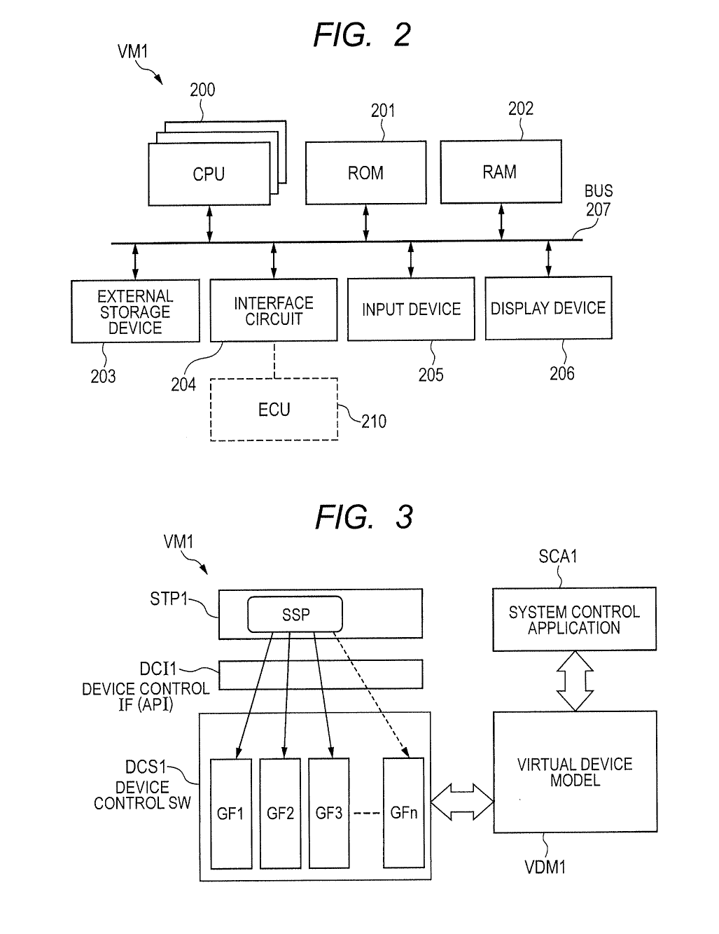

FIG. 2 is a conceptual diagram illustrating one example of a hardware configuration of the virtual development environment apparatus VM1 illustrated in FIG. 1.

The virtual development environment apparatus VM1 includes a plurality of CPUs (Central Processing Units) 200 as an arithmetic operation device, a ROM (Read Only Memory) 201 which stores desirable programs, a RAM (Read Only Memory) 202 which holds programs to be executed and various pieces of data and so forth. The virtual development environment apparatus VM1 further includes an external storage device 203 such as, for example, a hard dusk drive and so forth, an interface circuit 204, an input device 206 such as, for example, a keyboard and so forth, a display device 206 which displays input, output and so forth, a bus 207 which couples together the above-mentioned constitutional elements and so forth.

The interface circuit 204 includes many coupling terminals and these terminals are made to be electrically coupled with input and output terminals of an ECU 210 which has already been developed respectively. The ECU 210 is an ECU for, for example, vehicle engine control and includes a processor (CPU), memories (ROM and RAM), a plurality of peripheral circuits, an input/output circuit and so froth which are not illustrated in the drawing. The ECU 210 is configured to exchange various input/output signals (I/O signals) with the virtual development environment apparatus VM1 via the interface circuit 204. The CPUs 200 are provided plurally in number so as to disperse software processing in the virtual development environment apparatus VM1.

Pieces of software such as the system control application SCA1, the system test program STP1, the device control interface part DCI1, the device control software part DCS1, the virtual device model VDM1 and so forth which are illustrated in FIG. 1 are stored in storage devices such as the ROM 201, the external storage device 203 and so forth. These pieces of software are loaded to the RAM 202 as requested and executed by the plurality of CPUs 200 and thereby a virtual development environment including a software verification environment and a virtual model environment such as that illustrated in FIG. 1 is constructed.

The input device 205 and the display device 206 may be utilized as follows. For example, the plurality of scenarios set in the scenario setting part SSP may be input from the input device 205 and a result of input is displayed on the display device 206. In addition, one desirable scenario is selected from within the plurality of scenarios in accordance with the input from the input device 205 and the fault injection and it is possible to give the desirable control corresponding to the selected scenario to the virtual device model VDM1. It is possible to display a result of the operation of the system control application SCA1 performed for the operation of the virtual device model VDM1 based on the selected scenario on the display device 206 via the system test program STP1.

FIG. 3 illustrates one configuration example of the device control software part DCS1 illustrated in FIG. 1.

The device control software part DCS1 is configured to operate in an event-driven state on the basis of one scenario selected from within the plurality of scenarios set in the scenario setting part SSP of the virtual device model VDM1. Therefore, the device control software part DCS1 is provided with a plurality of general-purpose functions GF1 to GFn. The respective general-purpose functions FG1 to GFn are regarded as an assembly of the general-purpose functions used to control operations of the virtual device model VDM1 such as an operation of changing the state of the virtual device model VDM1, an operation of causing the failed state to occur in the virtual device model VDM1 and so forth.

The general-purpose functions GF1 to GFn are called in the event-driven state in accordance with times and execution order of the general-purpose functions which are defined in the selected scenario and one or a plurality of scenario(s) in the called general-purpose functions GF1 to GFn is/are sequentially executed. For example, in a case where such scheduling that “the general-purpose function GF1 is called and executed, the general-purpose function GF2 is called and executed 10 ms later, and the general-purpose function GF3 is called and executed 10 ms later” is defined, the three general-purpose functions GF1, GF2 and GF3 are sequentially called and executed with also the execution time of each general-purpose function being taken into consideration. That is, it is possible to define combinations of the various general-purpose functions, the execution order thereof and the execution times thereof as scheduling by defining the execution order of the general-purpose functions to be executed and the execution times of the general-purpose functions to be executed as the scenario. As a result, scheduling which indicates various operations of the virtual device model VDM1 becomes possible. It becomes possible to draw up comparatively with ease a schedule of controlling the operation of the virtual device model VDM1 in units of the plurality of scenarios (test patterns) to be set in the scenario setting part SSP. It becomes possible to realize various scenarios by performing calling that a time axis is taken into consideration by the scenario setting part SSP of the system test program STP1 which is set as a caller program.

Each of the general-purpose functions GF1 to GFn has a general-purpose single control function not involved in the time axis such as, for example, 1) GF1: the function of generating an exception of x, 2) GF2: the function of fixing a register to a value of y, 3) GF3: the function of rewriting the register to a value of z, . . . and N) GFn: the function of stopping a clock and so forth. That is, the microcomputer the operation of which is simulated by the virtual device model VDM1 includes a plurality of control registers and a plurality of control bits as generally known. Each of the general-purpose functions GF1 to GFn is set as the general-purpose single control function which optionally changes values of one control register and one control bit which are respectively selected from within the plurality of control registers and the plurality of control bits.

The following configuration may be also adopted as another example of each of the general-purpose functions GF1 to GFn.

In a case where the virtual device model VDM1 is set as the model of the microcomputer, built-in circuit modules which are included in the microcomputer may be configured as follows. That is, the built-in circuit modules may be configured as, for example, a CPU, a RAM, an interruption control circuit, an analog-to-digital conversion circuit (ADC), a dynamic memory access circuit (DMAC), a timer circuit (TM), a CAN (Controller Area Network) interface circuit, a LIN (Local Interconnect Network) interface circuit, a serial communication interface circuit (SCI), a clock generation circuit, a power source control circuit and so forth. In this case, the above-mentioned built-in circuit modules are produced as the general-purpose functions GF1 to GFn module by module. Then, a function of performing desirable control on an address which is allocated to each module, for example, addresses of each control register and each control bit may be defined as a general-purpose function of each module. The desirable control is defined as an operation of writing desirable data into the addresses of each control register and each control bit. In addition, the desirable control also includes an operation of writing desirable data for controlling a behavior such as an interruption timing of the microcomputer and so forth and the operation of the microcomputer. Control of the behavior such as the interruption timing and so forth may be regarded as control of a timing of changing values of an interrupt control bit provided in the built-in circuit module and an interrupt control bit provided in the interrupt control circuit.

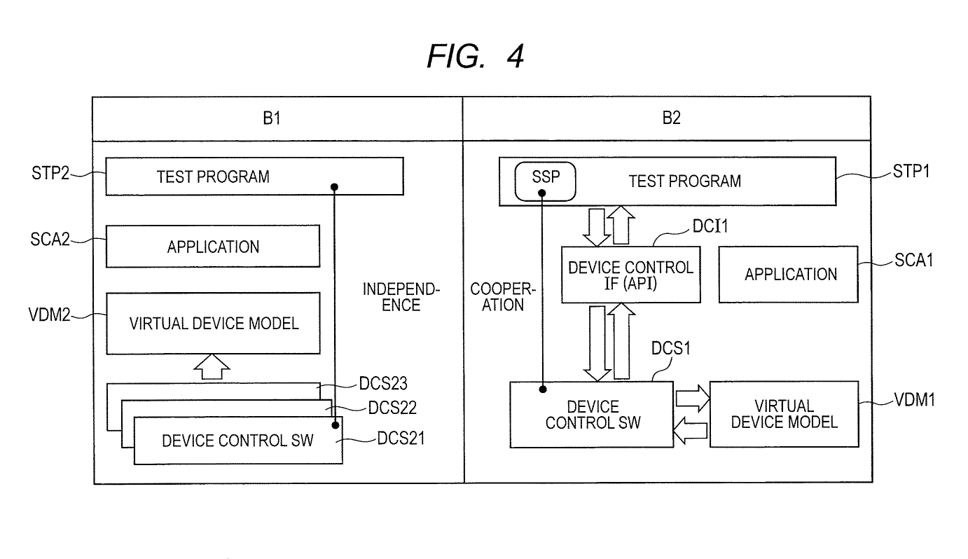

FIG. 4 illustrates one example of the virtual development environment B1 as the comparative example and the virtual development environment B2 according to the first embodiment in the form that the configuration illustrated in FIG. 1 is simplified. Incidentally, description of the parts which are described with reference to FIG. 1 is omitted.

In the virtual development environment B1, a system test program STP2, a system control application SCA2 and a virtual device model VDM2 are respectively equivalent to the system test program STP1, the system control application SCA1, the system control application SCA1 and the virtual device model VDM1 which are described with reference to FIG. 1. On the other hand, device control software parts DCS21, DCS22 and DCS23 are different from the device control software part DCS1 which is described with reference to FIG. 1 and FIG. 3.

In the virtual development environment B1, scenarios of the three device control software parts DCS21, DCS22 and DCS23 which are exemplified in FIG. 4 are mutually different. Although the three scenarios are illustrated in FIG. 4 in order to avoid complexity of the drawing, a large number of scenarios would be prepared and formed in reality and therefore there is such an issue that an enormous amount of time is taken for preparation and formation of the scenarios. For example, “a value of A is changed to a X ms (milliseconds) later, the value of A is returned to its initial value Y ms (milliseconds) later, a system error is caused to occur at the address RR Z ms (milliseconds) later, . . . ”, “AO is called, a value of B is changed L ms (milliseconds) later, the value of B is returned to its initial value M ms (milliseconds) later, the system error is caused to occur at the address NN, . . . ” and so forth may be given as examples of the scenario. That is, in each scenario, a combination of a time element with an operation which is expected to be executed at that time point is described in script language. Since the scenario is described in script language, there is such an issue that the number of engineers for the script language is small in comparison with the number of engineers for the C language and a longer time is taken for formation and preparation of the enormous number of scenarios. In addition, for example, when the scenario of the device control software part DCS21 is executed, only the scenario of the device control software part DCS21 is loaded to the RAM 202 and is executed. This scenario execution system is regarded as a scenario-driven system. Therefore, since the system test program STP2 and the device control software parts DCS21, DCS22 and DCS23 are configured to be independent of one another, there is also such an issue that it is difficult to perform verification in a state where the system test program STP2 and the device control software parts DCS21, DCS22 and DCS23 are cooperated with one another.

On the other hand, in the virtual development environment B2 according to the first embodiment, it is possible for the system test program STP1 to give the desirable control (including the fault injection) to the virtual device model VDM1 via the interface section IFP1, that is, the device control interface part DCI1 and the device control software part DCS1 as described with reference to FIG. 1 and FIG. 3. Therefore, since the system test program STP1 and the device control software section DCS1 operate in cooperation with each other so as to allow execution of the plurality of scenarios defined in the scenario setting part SSP of the system test program STP1, verification of the system control application SCA1 becomes possible by the various scenarios. The plurality of general-purpose functions GF1 to GFn are defined in the device control software part DCS1 and the device control software part DCS1 is not such a software part that the scenario itself is defined as the device control software parts DCS21 to DCS23 in the virtual development environment B2. In the plurality of general-purpose functions GF1 to GFn of the device control software part DCS1, selection and execution of the general-purpose functions are scheduled in the event-driven state by the scenarios defined in the scenario setting part SSP of the system test program STP1. In formation of the plurality of scenarios and the plurality of general-purpose functions GF1 to GFn, they may be formed in, for example, the C language. The number of engineers for the C language is larger than the number of engineers for the script language. Therefore, it is possible to form the plurality of scenarios and the plurality of general-purpose functions GF1 to GFn used for freely controlling the operation of the virtual device model VDM1 in a comparatively short time. As definitions of the general-purpose functions GF1 to GFn using the C language, there exist, for example, FuncA(a) (the value of A is changed to a), FuncSysError (b) (the system error is caused to occur at the address b) and so forth.

According to the first embodiment, the interface section IFP1 (the device control interface part DCI1 and the device control software part DCS1) used for coupling together the program (the system test program STP1) in the software verification environment and the virtual device model VDM1 in the virtual model environment is provided. Therefore, it is possible to give various operations from the system test program STP1 to the virtual device model VDM1 at free timings. Thereby, it becomes possible to construct an integrated verification system. Accordingly, to the system control application SCA1 which is set as a verification target, it becomes possible to directly give a signal to the system control application SCA1 from the interface section IFP1 (the device control interface part DCI1 and the device control software part DCS1) concurrently with occurrence of various faults and so forth in the virtual device model VDM1. Thus, it is possible to improve freedom of verification for the system control application SCA1 and to promote improvement of verification efficiency and improvement of verification quality.

Control of the virtual device model VDM1 coping with the various scenarios becomes possible and thereby it becomes possible to improve a verification coverage rate of the system control application SCA1 which operates on the virtual device model VDM1. Upgrading of the system control application SCA1 is promoted by improvement of the verification coverage rate. Accordingly, it becomes possible to cope with application of the functional safety standard ISO26262 and standard conformance.

### Second Embodiment

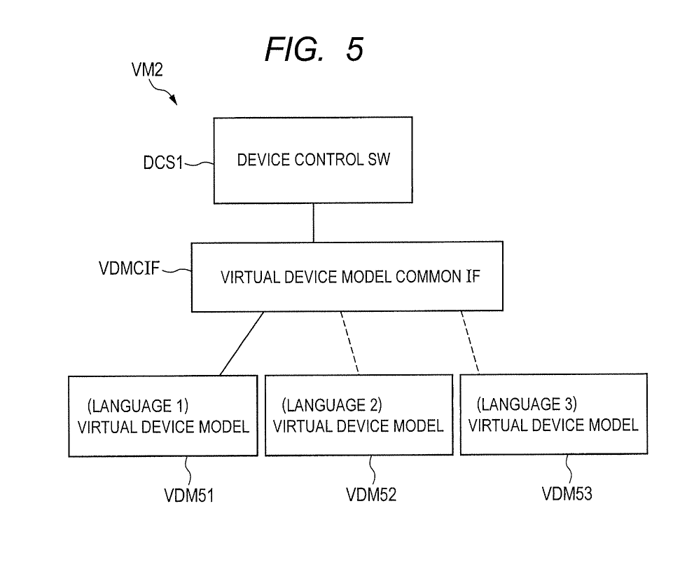

FIG. 5 is a conceptual diagram illustrating one configuration example of a virtual development environment apparatus VM2 according to a second embodiment.

In the virtual development environment apparatus VM1 according to the first embodiment illustrated in FIG. 1 and FIG. 3, only one virtual device model VDM1 is described. In FIG. 5, a configuration of the virtual development environment apparatus VM2 that one desirable virtual device model is selected from within a plurality of virtual device models VDM51, VDM52 and VDM53 is illustrated. Incidentally, in FIG. 5, the configurations which are the same as those of the system control application SCA1, the system test program STP1 and the device control interface part DCI1 described with reference to FIG. 1 are adoptable and therefore illustration of these configurations is omitted for simplification of the drawing.

The three virtual device models VDM51, VDM52 and VDM53 are illustrated in FIG. 5. The virtual device models VDM51, VDM52 and VDM53 are virtual device models which are formed in mutually different languages for one microprocessor and one microcomputer the operations of which are simulated. The virtual device model VDM51 is formed in a language 1, the virtual device model VDM52 is formed in a language 2 and the virtual device mode VDM53 is formed in a language 3 respectively.

A common interface section (a virtual device model common I/F) VDMCIF which is set as a second interface section is provided in order to control one virtual device model selected from within the three virtual device models VDM51, VDM52 and VDM53 by the device control software part DCS1. The common interface section VDMCIF has a selection function for selecting a desirable virtual device model. In addition, the common interface section VDMCIF has a function of absorbing a difference among the virtual device models VDM51, VDM52 and VDM53 described in the mutually different languages.

Thereby, even when the virtual device model to be utilized is changed, it is possible to provide the common virtual development environment and the common virtual development apparatus by the common interface section VDMCIF. Accordingly, even in a case where a changeover of the virtual development environment (a changeover of the virtual device model) occurs, a changeover of other constituent parts (the system control application SCA1, the system test program STP1, the device control interface part DCI1 and the device control software part DCS1) of the virtual development environment apparatus becomes unnecessary. Thereby, it is possible to greatly reduce man-hour used for changing the virtual development environment.

### Application Example

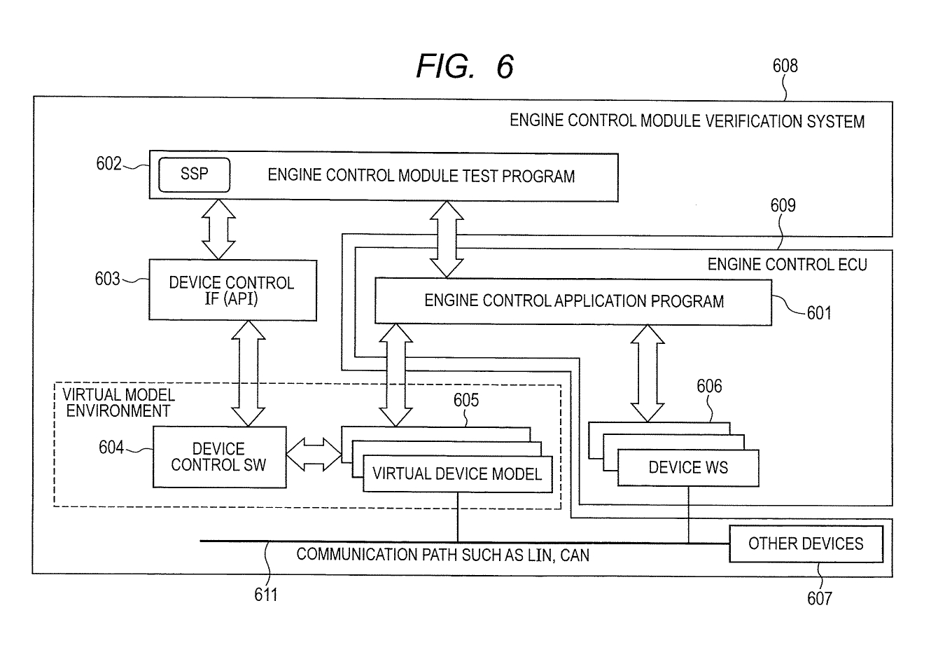

FIG. 6 illustrates an application example of the virtual development environment apparatus VM1 according to the first embodiment. Incidentally, although in the following, description will be made about an engine control module verification system, it goes without saying that the virtual development environment apparatus is widely applicable to on-vehicle component control module verification systems not limited to the engine control module verification system.

FIG. 6 illustrates the application example in a case where the virtual development environment apparatus according to the first embodiment is used in an engine control module verification system 608. An engine control ECU 609 which is set as the verification target is configured by an engine control application program 601 and a device group (a device WS) 606 including a microprocessor, a peripheral circuit IP and so forth used for operating the engine control application program 601. The engine control ECU 609 which is an on-vehicle electronic control unit controls the engine of a not illustrated vehicle together with other devices 607 such as external various sensors and actuators, other ECUs and so forth via a communication bus and a communication path 611 such as LIN, CAN and so forth. The various sensors and actuators and the other ECUs may be, for example, a vehicle surrounding monitoring radar module, a temperature sensor module, a pressure sensor module, a brake motor module, a steering control motor module, a body control ECU, a chassis control ECU and so forth.

The engine control module verification system 608 is a test bench for verifying the engine control ECU 609. The engine control module verification system 608 is configured by an engine control module test program 602 which includes the scenario setting part SSP, a device control interface part (a device control IF (API)) 603, a device control software part (a device control SW) 604 and a virtual device model 605. The device control interface part 603 and the device control software part 604 respectively correspond to the device control interface part DCI1 and the device control software part DCS1 included in the interface section IFP1 illustrated in FIG. 1. The virtual device model 605 is a software model which is able to simulate the operation of a semiconductor device such as the microcomputer and so forth adopted in the on-vehicle electronic control unit in a software-based manner.

The engine control module test program 602 sends various signals to the engine control application 601 and brings the engine control application 601 into an execution state. In addition, the engine control module test program 602 sends and receives various signals to and from the virtual device model 605 which simulates the operation of the device group 606 via the device control interface part 603 and the device control software part 604 and thereby changes the state of the virtual device model 605 by causing a desirable fault to occur in the virtual device model 605 and so forth.

The device control interface part 603 is provided with many general-purpose functions (GF1 to GFn) for controlling the virtual device model 605 as described with reference to FIG. 3. It is possible for the engine control module test program 602 to control the virtual device model 605 by using the device control interface part 603 via the device control software part 604 at a requisite timing.

The virtual device model 605 and the device group 606 have mutually equivalent functions and, for example, it is possible to operate the engine control ECU 609 by replacing the virtual device model 605 and the device group 606 with each other by using, for example, the interface circuit 204 illustrated in FIG. 2. Thereby, it is possible to perform verification of the engine control ECU 609 in a time period that acquisition of the device group 606 is difficult. In addition, the virtual device model 605 is also utilized for simulation of a fault which would not occur unless otherwise the inside of the device group 606 is destroyed also after acquisition of the device group 606. Further, it becomes possible to perform a comprehensive inspection which would depend on the timing including the other devices 607 by controlling the virtual device model 605 from the engine module verification system 608 at the requisite timing.

Although in the foregoing, the disclosure which has been made by the inventors and others has been specifically described on the basis of the embodiments, the present disclosure is not limited to the above-mentioned embodiments and it goes without saying that various alterations and modifications are possible within a range not deviating from the gist thereof.

What is claimed is:

1. An arithmetic operation device comprising:
a test program;
a virtual device model; and
an interface section for bringing the test program into correspondence with the virtual device model,
wherein desirable control is given from the test program to the virtual device model via the interface section.

2. The arithmetic operation device according to claim 1,
wherein the interface section includes a device control interface part and a device control software part.

3. The arithmetic operation device according to claim 2,
wherein the test program includes a scenario setting part,
wherein the device control software part includes a plurality of general-purpose functions, and
wherein one desirable general-purpose function is selected from within the general-purpose functions and the desirable control is given to the virtual device model on the basis of a definition of the scenario setting part.

4. The arithmetic operation device according to claim 3,
wherein the desirable control is given in order to cause a failed state to occur in the virtual device model or to cause a response delay to occur in the virtual device model.

5. The arithmetic operation device according to claim 4,
wherein the virtual device model is adapted to simulate an operation of a microcomputer, and
wherein each of the general-purpose functions is a single general-purpose control function of changing a value of one control register selected from within a plurality of control registers or of one control bit selected from within a plurality of control bits of the microcomputer or controlling a behavior of the microcomputer such as an interruption timing and so forth.

6. The arithmetic operation device according to claim 5,
wherein the scenario setting part defines a plurality of scenarios,
wherein each of the scenarios includes descriptions on execution order of the general-purpose functions to be executed and execution times of the general-purpose functions to be executed, and
wherein in a case where one scenario is selected from within the scenarios, one selected general-purpose function is executed in accordance with the description of the selected scenario in an event-driven state.

7. The arithmetic operation device according to claim 6, further comprising:
an input device,
wherein definition of the scenarios is made by input from the input device.

8. The arithmetic operation device according to claim 2, further comprising:
a common interface provided between the device control software part and the virtual device model,
wherein the virtual device model is used to simulate an operation of a microcomputer, and
wherein the virtual device model is one virtual device model which is selected from within a plurality of the virtual device models which are made by using mutually different languages by the common interface as for the microprocessor the operation of which is simulated.

9. A virtual development environment apparatus comprising:
an arithmetic operation device,
wherein the arithmetic operation device executes
a test program,
a system application,
a virtual device model,
a first interface section which is adapted to couple together the test program and the virtual device model and includes a device control interface part and a device control software part, and
a second interface section which is provided between the device control software part and the virtual device model,
wherein the virtual device model is adapted to simulate an operation of a microcomputer, and
wherein the virtual device model is one virtual device model which is selected from within a plurality of the virtual device models which are made by using mutually different languages by the common interface as for the microprocessor the operation of which is simulated.

10. A virtual development environment apparatus comprising:
an arithmetic operation device,
wherein the virtual development environment apparatus is utilized for development of an engine control module,
wherein the arithmetic operation device constructs a virtual development environment by executing
a system application program for engine control which is loaded on an on-vehicle electronic control device for engine control,
a test program for engine control module adapted to verify the system application program for engine control,
a virtual device model which simulates an operation of a microcomputer to be adopted in the on-vehicle electronic control device, and
an interface section for coupling together the test program for engine control module and the virtual device model,
gives desirable control from the test program for engine control module to the virtual device model via the interface section and thereby changes the operation of the virtual device model, and
gives a change in operation of the virtual device model to the system application for engine control and thereby verifies the system application program for engine control in accordance with the test program for engine control module.

11. The virtual development environment apparatus according to claim 10,
wherein the desirable control given in order to cause a failed state to occur in the virtual device model or to cause a response delay to occur in the virtual device model.
